(19) United States
(12) Patent Application Publication
(10) Pub. No.: US 2019/0305823 A1
(43) Pub. Date: Oct. 3, 2019

(54) Data Communication Hardware Module for In-Line Power Connection with Equipment

(71) Applicant: Mobile Tech, Inc., Lake Oswego, OR (US)

(72) Inventor: Robert Logan Blaser, Farmington, UT (US)

(21) Appl. No.: 16/370,463

(22) Filed: Mar. 29, 2019

Related U.S. Application Data
(60) Provisional application No. 62/650,792, filed on Mar. 30, 2018.

(51) Int. Cl. H04B 3/54; H04B 1/40

(52) U.S. Cl. CPC H04B 3/542; H04B 1/40

(57) ABSTRACT

Disclosed herein are a number of example embodiments where a hardware module is in-line power connected with an item of equipment such as a product display assembly, where the hardware module can encode data within a power signal delivered to the equipment item. The hardware module can also support data communication from the equipment item through modulation by the equipment item of current drawn from the hardware module. Such a hardware module can provide location awareness for the equipment item.

### CROSS-REFERENCE AND PRIORITY CLAIM TO RELATED PATENT APPLICATION

This patent application claims priority to U.S. provisional patent application Ser. No. 62/650,792, filed Mar. 30, 2018, entitled “Data Communication Hardware Module for In-Line Power Connection with Equipment”, the entire disclosure of which is incorporated herein by reference.

### INTRODUCTION

Many products such as electronic devices (particularly hand-held electronics such as smart phones, tablet computers, digital cameras, etc.) are displayed in retail stores at individual post positions on countertop or wall-rack displays. A product display assembly at each post position is typically employed to facilitate the presentation of these products to customers. The inventor believes that there is a need in the art for innovative new ways of communicating with such product display assemblies as well as tracking the locations of the electronic devices presented by such product display assemblies as well as tracking the locations of various components of the product display assemblies. Moreover, the inventor believes that such needs also exist in connection with other items of equipment such as docking stations for electronic devices.

Toward this end, the inventor discloses a variety of embodiments for a hardware module that can communicate with an item of equipment such as a product display assembly and a docking station.

For example, the inventor discloses an apparatus comprising a hardware module for in-line power connection with an item of equipment, the hardware module comprising (1) a first interface, (2) a second interface, and (3) a circuit that connects the first interface with the second interface, wherein the first interface is configured to receive power, wherein the circuit is configured to (1) generate a power signal based on the received power, (2) encode data in the power signal, and (3) provide the power signal with the encoded data therein to the second interface, and wherein the second interface is configured to output the power signal with the encoded data therein for receipt by the equipment item to thereby communicate the data to the equipment item.

As another example, the inventor discloses a system comprising: (i) an equipment item having a power input, and (ii) a hardware module comprising (1) a first interface, (2) a second interface, and (3) a circuit that connects the first interface with the second interface, wherein the first interface is configured to interface the circuit with a power source, wherein the second interface is configured to interface the circuit with the power input of the equipment item, and wherein the circuit is configured to (1) generate a power signal based on power received from a power source through the first interface, (2) encode data in the power signal, and (3) communicate the power signal, including the encoded data, to the equipment item via the second interface and the power input.

As yet another example, the inventor discloses a method comprising: (i) connecting a hardware module between a power input of an item of equipment and a power source, and (ii) in response to the connecting, the hardware module (1) receiving power from the power source, (2) generating a power signal based on the received power, (3) encoding data in the power signal, and (4) providing the power signal, including the encoded data, to the power input of the equipment item.

The data can be encoded in the power signal using voltage modulation techniques. Also, the circuit can receive data from the equipment item by demodulating a modulated current draw from the equipment item, where the modulated current draw encodes the data from the equipment item. Furthermore, as explained below, such as an apparatus, system, and/or method can facilitate location awareness for the equipment item by assigning an identifier to the hardware module, associating the hardware module with a location, and tying the equipment item to the hardware module identifier.

As another example, the inventor discloses an apparatus comprising a hardware module for in-line power connection with an item of equipment, the hardware module comprising (1) a first interface, (2) a second interface, and (3) a circuit that connects the first interface with the second interface, wherein the first interface configured to receive power, wherein the second interface is configured to output power to the equipment item, and wherein the circuit configured to (1) read a modulated current draw from the equipment item through the second interface, wherein the modulated current draw encodes data from the equipment item, (2) demodulate the modulated current draw, and (3) extract the data from the demodulated current draw.

As yet another example, the inventor discloses a method comprising: (i) in-line power connecting a component with an item of equipment, wherein the component has a component identifier, and wherein the equipment item is associated with a moveable electronic device, (ii) the component providing a power signal to the equipment item, (iii) the component communicating the component identifier to the equipment item by encoding the component identifier in the power signal via voltage modulation, (iv) the equipment item decoding the component identifier from the voltage modulated power signal, (v) the equipment item reading an identifier for the moveable electronic device, and (vi) the equipment item wirelessly transmitting a pairing of the component identifier and the moveable electronic device identifier to a remote computer system. Also disclosed are example embodiments of a system for carrying out this method.

Further still, the inventor discloses an apparatus comprising a puck assembly configured to receive a power signal from a remote component, the puck assembly comprising a circuit configured to bi-directionally communicate with the component using voltage demodulation of a modulated power signal for data received from the component that is encoded within the power signal and current modulation of a current draw from the component for data to be sent to the component.

These and other features and advantages of the present invention will be described hereinafter to those having ordinary skill in the art.

### BRIEF DESCRIPTION OF THE DRAWINGS

FIG. 1 discloses an example connected environment system of product display assemblies.

FIGS. 2A and 2B show an example product display assembly.

FIGS. 3A and 3B show an example product display assembly in combination with an example embodiment of a hardware module.

FIGS. 4A-4C show examples of how the FIGS. 3A and 3B embodiments can employ wireless connectivity.

FIGS. 5A-5C show example embodiments of the hardware module.

FIG. 6 shows an example process flow for use by the hardware module to encode data in a power signal.

FIG. 7 shows another example process flow for use by the hardware module to encode data in a power signal.

FIG. 8A shows an example process flow for use by the hardware module to decode data from a modulated current draw.

FIG. 8B shows another example process flow for use by the hardware module to decode data from a modulated current draw.

FIG. 9 shows an example embodiment of a power and data circuit for use in a hardware module.

FIG. 10 shows an example circuit diagram of a power and data circuit for use in a hardware module.

FIG. 11 shows an example process flow for use by the puck assembly to decode data from a voltage-modulated power signal.

FIG. 12 shows an example process flow for use by the puck assembly to encode data in a modulated current draw.

FIG. 13 shows an example embodiment of puck assembly circuitry for communicating with the hardware module.

FIG. 14 shows an example circuit diagram of the receive and transmit circuits of FIG. 13.

FIG. 15A shows an example process flow for end-to-end data communication initiated by a hardware module.

FIG. 15B shows an example process flow for end-to-end data communication initiated by a puck assembly.

FIGS. 16A, 16B, 17A, and 17B show example process flows that leverage a hardware module to provide location-awareness regarding where puck assemblies and electronic devices are located relative to known locations such as post positions.

FIGS. 18A-C show example product display assemblies.

FIGS. 19A-E describe an example protocol that can be used by the hardware module and puck assembly to communicate messages to each other.

### DETAILED DESCRIPTION OF EXAMPLE EMBODIMENTS

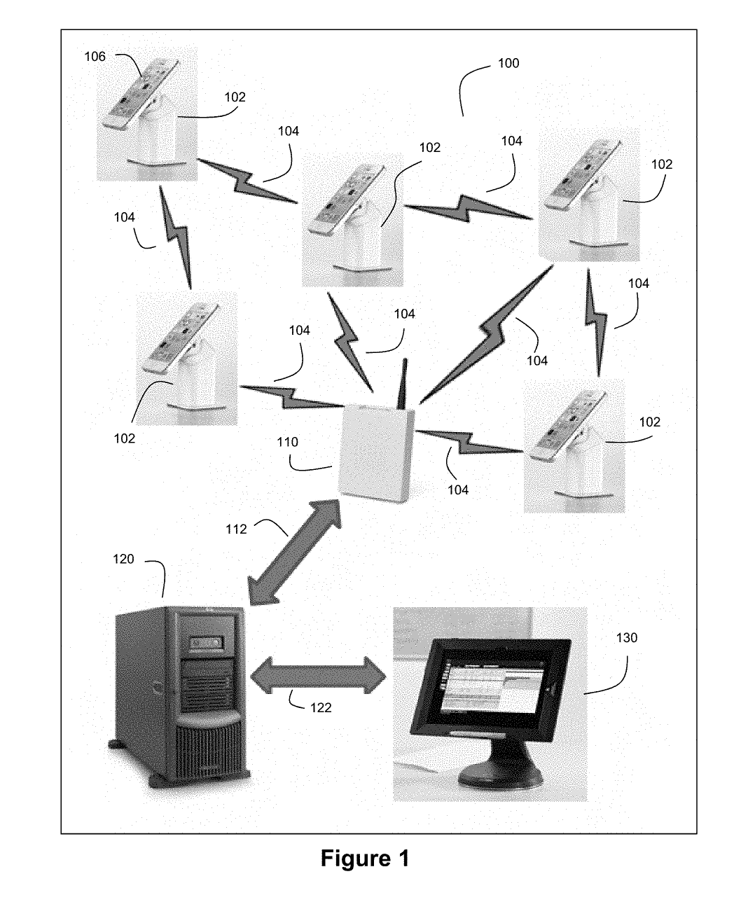

FIG. 1 shows an example system 100 in which embodiments of the inventive hardware module described herein can be deployed. The system 100 may include a plurality of product display assemblies 102 that are linked together via wireless signals 104 to form a wireless network such as a wireless mesh network. The product display assemblies 102 can be configured to secure and display products such as electronic devices 106 (e.g., smart phones, tablet computers, smart watches, cameras, etc.) to consumers. The wireless mesh network can be wirelessly connected with one or more remote computer systems such as a gateway computer 110 and/or server 120. In the example of FIG. 1, the product display assemblies 102 can wirelessly communicate with the gateway computer 110 via the wireless mesh network, and the gateway computer 110 can communicate over a network 112 with server 120 via a communication protocol such as RS-232 (although it should be understood that alternative communication protocols could be employed). Through these connections, the server 120 can collect data from the various product display assemblies 102 and make such data available to remote users via a user interface application 130 linked into the server 120 via a network connection 122 (e.g., a WiFi connection, an Ethernet connection, etc.). Additional details about example embodiments of the wirelessly connected environment of system 100 can be found in US Pat App Pub 2017/0164314, the entire disclosure of which is incorporated herein by reference.

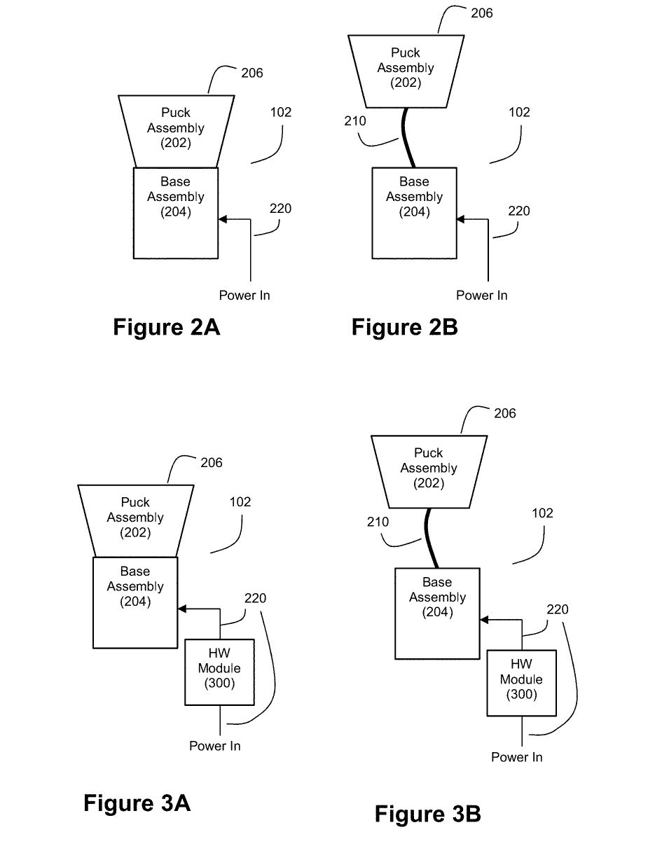

FIGS. 2A and 2B show an example embodiment of a anti product display assembly 102 that includes a puck assembly 202 and a base assembly 204. Tether 210 connects the puck assembly 202 with base assembly 204.

An electronic device can be mounted on surface 206 of the puck assembly 202 so that the electronic device can be securely displayed to customers in a store. The puck assembly 202 is moveable between a rest position and a lift position. When in the rest position, the puck assembly 202 contacts the base assembly 204, as shown in FIG. 2A. Power can be provided to the base assembly 204 via input power line 220, and this power can be distributed to the puck assembly 202. When in the lift position, the puck assembly 202 separates from the base assembly 204, as shown by FIG. 2B. FIG. 2B also shows how the tether 210 remains connected to the puck assembly 202 and the base assembly 204 when the puck assembly is in the lift position. This allows for a customer to pick up, hold, and inspect the electronic device when making a purchase decision. To provide ease of handling, tether 210 may be a retractable tether. However, it should also be noted that some practitioners may choose to omit the tether 210 from the product display assembly 102, in which case the puck assembly 202 would be completely separated from the base assembly 204 when the puck assembly is in the lift position.

Examples of product display assemblies 102 that can be adapted for use in the practice of the embodiments described herein are disclosed in U.S. Pat. Nos. 8,558,688, 8,698,617, 8,698,618, and 9,786,140; and U.S. Patent Application Publication Nos. 2014/0159898, 2017/0032636, 2017/0164314, and 2017/0300721, the entire disclosures of each of which are incorporated herein by reference.

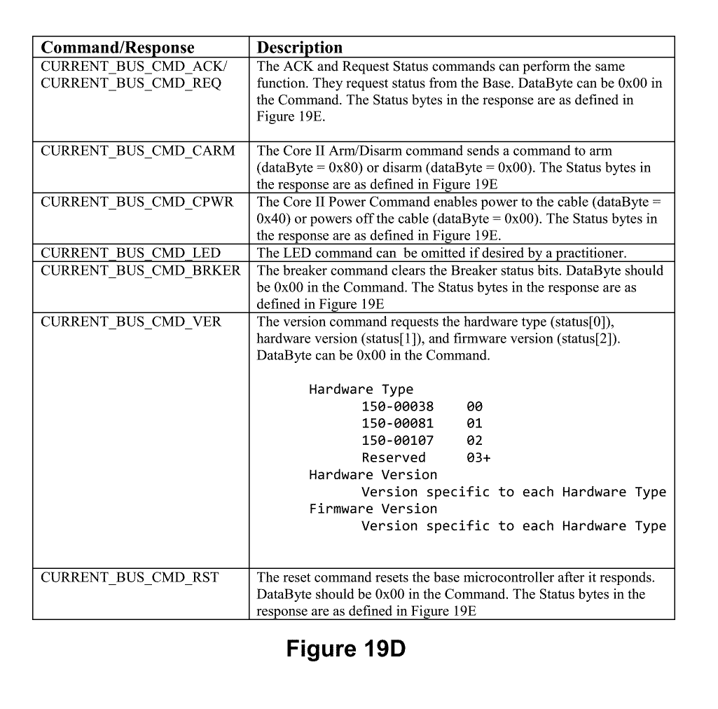

For example, FIGS. 18A and 18B reproduce FIGS. 27 and 28 from the incorporated '140 patent and show an example product display assembly 102 that is further described in the '140 patent. The product display assembly 102 shown by FIGS. 18A and 18B includes a puck assembly 202, a base assembly 204, and a tether 210. A power cable 1812 provides an electrical connection between the puck assembly 202 and an electronic device 106 for display through which the electronic device 106 can be charged. The puck assembly 202 can receive power from a power source via the base assembly 204 when the puck assembly is at rest, as shown in FIG. 2A. Contacts included on the puck assembly and base assembly can contact each other when the puck assembly 202 is at rest, thereby forming an electrical connection through which power can be delivered from a power source to the puck assembly 202 via the base assembly 204 and the electrical connection formed by the contacts. When the puck assembly 202 is lifted, the contacts lose contact with each other, thereby breaking the electrical connection. Optionally, a battery or other power storage device can be included in the puck assembly 202 to store power for use by the puck assembly 202 when the puck assembly is in the lift position.

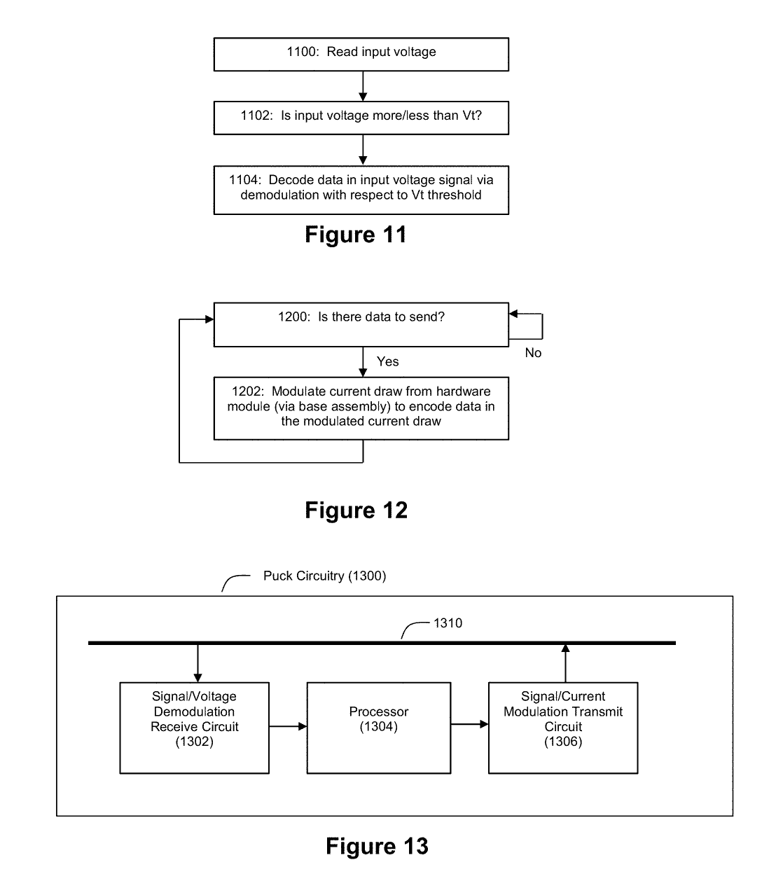

As another example, FIG. 18C reproduces FIG. 8 from the incorporated '140 patent and shows an example product display assembly 102 that is further described in the '140 patent. In this view, an example product display assembly 102 is shown in an exploded manner where various components of a puck assembly 202, a base assembly 204, and a tether 210 can be seen.

As explained in the above-referenced and incorporated patents and patent applications, circuitry in the puck assembly 202 can be used to detect events such as lifts of the puck assembly and unauthorized removal of the electronic device 106 from the puck assembly 202. With these prior system designs, data about lift events and security conditions could be communicated wirelessly via the puck (e.g., via a wireless transmitter in the puck or by using the tether 210 as an RF antenna). Alternately, such data could be communicated over a conductor within the tether 210 itself as a standard signal using the conventional RF signal approaches. However, as explained above, the inventor believes that new and innovative manners of data communication using hardware modules as described herein can be advantageous.

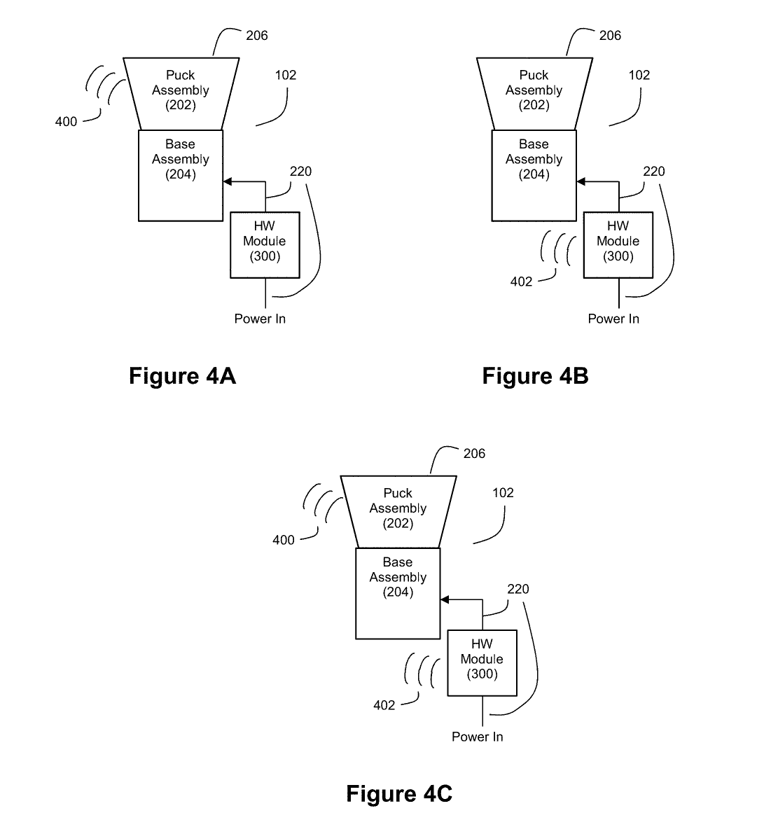

FIGS. 3A and 3B show an example embodiment of the product display assembly 102 of FIGS. 2A and 2B with a hardware module 300 that is connected in-line with the power input 220 for the base assembly 204. As explained above and below, example embodiments of the hardware module 300 described herein can open new capabilities for the product display assembly with respect to location awareness and data communications. For example, making the product display assemblies 102 location-aware can be a challenge. Base assemblies 204 are typically fixedly secured to surfaces such as counters and walls in a retail store, and the locations of these fixtures can be referred to as post positions. The fixed nature of securing base assemblies 204 to counters or walls makes moving base assemblies 204 to new post positions inconvenient, time-consuming, and labor-intensive. Moreover, with many product display assemblies 102, the puck assemblies 202 can be detachable from the base assembly 204 and/or tether 210 to allow for swapping out puck assemblies 202 and/or their attached electronic devices 106 to new post positions. Given the potential for movement of puck assemblies 202 and/or electronic devices 106 to new post positions, remote location-aware tracking of electronic devices 106 can be a technical challenge.

In this regard, it is highly desirable to remotely track the precise location of electronic devices 106 in a retail store, and more specifically to know which electronic devices 106 are being displayed at which post positions. Merchandisers typically devise detailed planograms that will define which types of electronic devices 106 should be displayed at particular post positions in a retail store to achieve desired retail merchandising goals. For example, a merchandiser may want the newest and most expensive model of a particular brand of smart phone displayed at post positions 1-4 (which are expected to experience the most customer traffic), while older or less expensive models of a smart phone are to be displayed at post positions 5-8 (which are expected to experience less customer traffic). Monitoring planogram compliance can be a major burden at retail stores, and the inventor believes that example embodiments of the hardware module described herein can help facilitate effective remote monitoring of planogram compliance by providing an effective mechanism by which identifiers for electronic devices 106, puck assemblies 202, and hardware modules 300 can be tracked and linked with post positions, even in situations where the base assemblies 204 themselves are not location-aware.

Further still, by leveraging wireless communication capabilities, data can be communicated between the puck assemblies 202 and hardware modules 300 to further enhance the connectivity of the system 100.

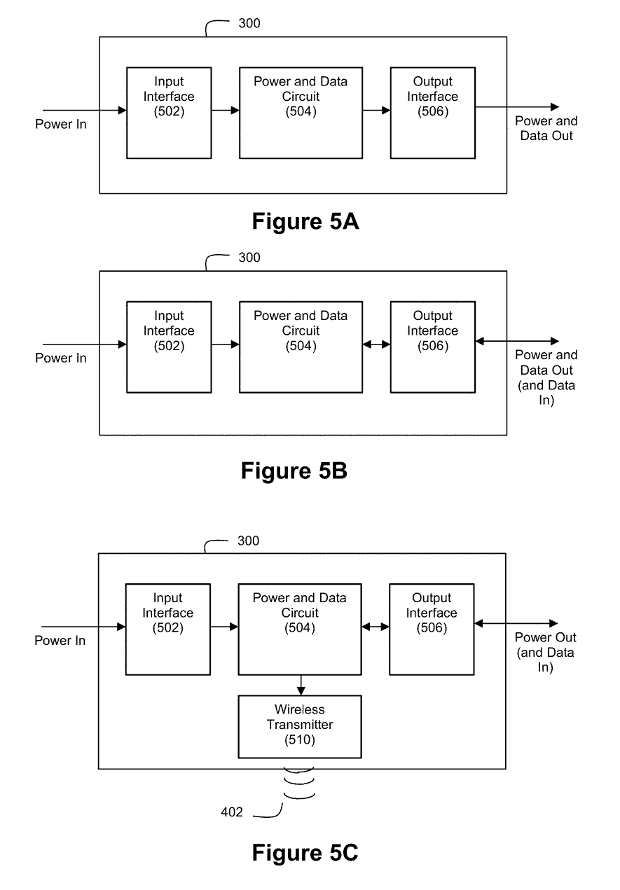

FIG. 4A depicts an example where the puck assembly 202 is configured with wireless communication capabilities. In this example, the hardware module 300 can send a message to the puck assembly 202 via data encoded in the power signal on line 220, and the puck assembly 202 can communicate data derived from this message via wireless link 400 (which can be the wireless link 104 shown in FIG. 1). FIG. 4B depicts an example where the hardware module 300 is configured with wireless communication capabilities. In this example, the puck assembly 202 can send a message to the hardware module 300 via data encoded in the current draw on line 220 from the puck assembly 202, and the hardware module 300 can communicate data derived from this message via wireless link 402 (which can be the wireless link 104 shown in FIG. 1). An embodiment such as that shown in FIG. 4B can allow a non-wirelessly-enable product display assembly 102 to become wirelessly-enabled in response to the connection of the hardware module 300 to the power input line 220. FIG. 4C depicts an example where both the puck assembly 202 and the hardware module 300 are configured with wireless communication capabilities.

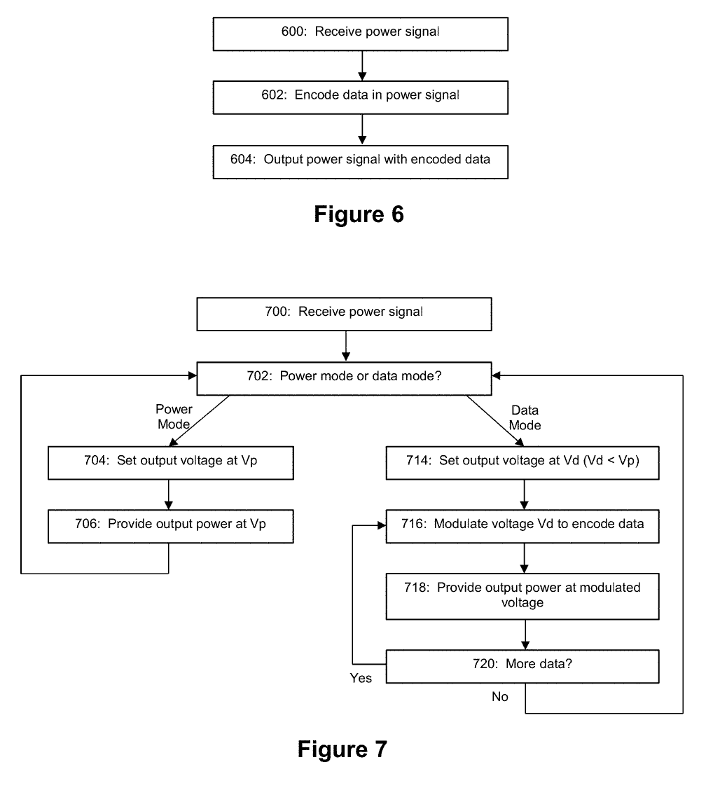

FIG. 5A depicts an example embodiment of the hardware module 300. In this example, the hardware module 300 comprises an input interface 502, a power and data circuit 504, and an output interface 506. These components can be enclosed in a housing such as a plastic or composite shell. As an example, the hardware module 300 can be arranged as a dongle for in-line power connection with the base assembly 204. However, it should be understood that the shape/form factor of the hardware module 300 need not exhibit a traditional dongle shape. The hardware module 300 can exhibit any of a number of shapes or form factors that would be desired by a practitioner. For example, the hardware module 300 can be shaped to correspond to a portion of the base assembly 204 to which it may connect.

The input interface 502 can be a connector that allows the hardware module 502 to receive power from a power line, and the output interface 506 can be a connector that allows the hardware module 502 to output power to the base assembly 204 via line 220. Through input interface 502, the hardware module 300 connects with a power supply. Through output interface 506, the hardware module 300 connects with a power input of the base assembly 204. As an example where the input power is DC power, the input interface 502 can be a DC barrel connector. In an example where the base assembly 204 receives DC input power, there can be a DC power brick that is plugged into an AC power source such as a wall outlet or power strip. The other end of the DC power brick would normally plug into a DC input port (which can be a female DC barrel connector) of the base assembly 204. However, with the hardware module being connected in-line with the power for the base assembly 204, the input interface 502 could thus be, for example, a female DC barrel connector that connects with an output male DC barrel connector of the power brick. The output interface 506 can then be a connector such as male DC barrel connector that then plugs into the female DC barrel connector of the base assembly 204. However, it should be understood that other types of interfaces for 502 and 506 could be employed. For example, if male and female connections are used, which connectors are male and which are female can be modified if desired. Further still, the connections need not be direct connections—for example, a cable can interconnect output interface 506 with the power input of the base assembly 204.

The power and data circuit 504 in the example of FIG. 5A can be configured to encode data into the outgoing power signal. The power and data circuit 504 may also store an identifier for the hardware module, which can be referred to as a Dongle ID (although it should be understood once again that the hardware module 300 need not necessarily be shaped as a traditional dongle). This Dongle ID is an example of the type of data that the power and data circuit 504 may encode into the outgoing power signal. As described below, the power and data circuit may include a voltage modulator for encoding the data into the outgoing power signal.

FIG. 5B depicts another example embodiment of the hardware module 300. In this example, the hardware module 300 supports bi-directional communication with the product display assembly 102. For communications to the product display assembly 102, the techniques described above in connection with FIG. 5A may be used. For communications from the product display assembly 102, the hardware module 300 may receive data from the puck assembly 202 (by way of the base assembly 204) via a modulation of the current drawn by the puck assembly 202. The power and data circuit 504 in the example of FIG. 5B can also be configured to decode and extract data from the modulated current draw. Examples of this are discussed below.

FIG. 5C depicts another example embodiment of the hardware module 300. In this example, the hardware module 300 can receive communications from the product display assembly 102, but it is not equipped to transmit communications to the product display assembly 102. As with the example embodiment of FIG. 5B, for communications from the product display assembly 102, the hardware module 300 may receive data from the puck assembly 202 (by way of the base assembly 204) via a modulation of the current drawn by the puck assembly 202. The power and data circuit 504 in the example of FIG. 5C can be configured to decode and extract data from the modulated current draw (but it need not include the capability to encode outgoing data via voltage modulation as discussed above in connection with FIG. 5A. The example of FIG. 5C also includes a wireless transmitter 510 that can wirelessly send the extracted data to a remote computer system. Thus, the hardware module 300 of FIG. 5C can be effective for wirelessly connecting a product display assembly 102 that lacks a wireless communication capability with a remote computer system.

Furthermore, it should be understood that the example hardware modules 300 of FIGS. 5A and 5B may include a wireless transmitter 510 if desired by a practitioner. Moreover, the wireless transmitter 510 could take the form of a wireless transceiver (or be replaced with a wireless receiver) if a practitioner also desires for the hardware module 300 to receive messages from the remote computer system. For example, a remote computer system can wirelessly send a message to a wireless transceiver or receiver in the hardware module 300, and then the hardware module 510, in response to this message from the remote computer system, could send a message to the product display assembly 102 over the power signal using voltage modulation techniques.

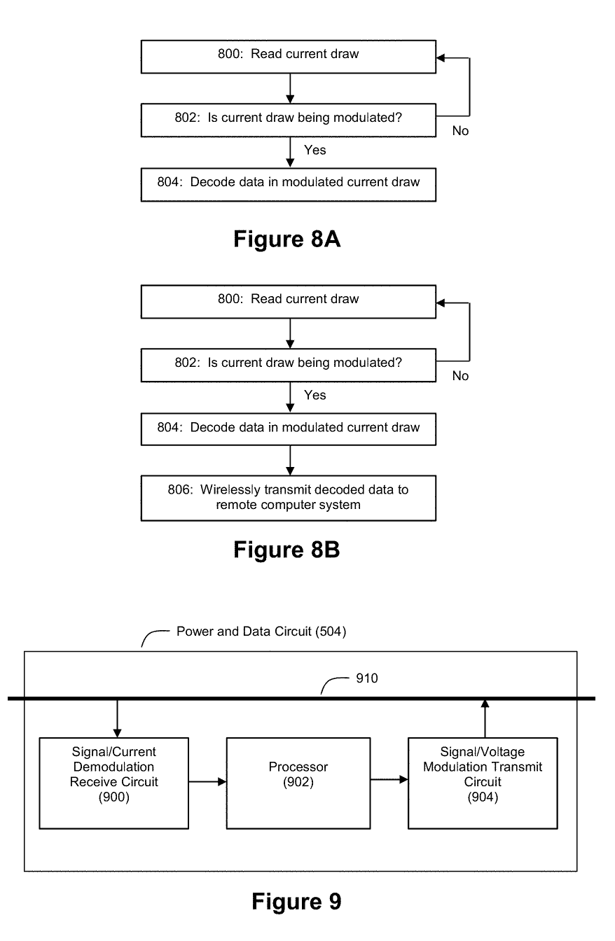

FIG. 6 depicts an example process flow that can be used by the hardware module 300 to send data to the product display assembly 102. At step 600, the hardware module 300 receives a power signal. This power can be received from a power source or power supply through input interface 502. As an example, this power signal can be a 5V DC signal that supports up to 3 A of current. However, it should be understood that other power signals could be used. For example, power signals associated with USBC may be used, such as one or more of 5V, 9V, 12V, 15V, and 20V signals that may support current capacities up to 5 A. Still other variations are possible. Then, at step 602, the power and data circuit 504 encodes data in a power signal. This encoding can be achieved by modulating the output voltage for the hardware module 300 between two voltages, V1 and V2. V1 can be used to encode a bit value of “0” and V2 can be used to encode a bit value of “1”. As examples, V1 can be 0V and V2 can be around 1.8V, although it should be understood that variations are possible. For a given data rate, the power and data circuit can encode bits of data by toggling the output voltage between V1 and V2 as appropriate for the subject data. The hardware module 604 then outputs, via output interface 506, a power signal with these modulated voltages to send data to the product display assembly 102 embedded within the power riding on power line 220. The data that gets encoded at step 602 can be any of a number of different types of data. For example, the data could be an identifier for the hardware module 300. The data could also be different types of command requests to be sent to the product display assembly 102 (e.g., requests for operating status, arming/disarming status, arming/disarming control, charge level, electronic device identifier, sensor status, alarm trigger status, breaker status, lift history, etc.).

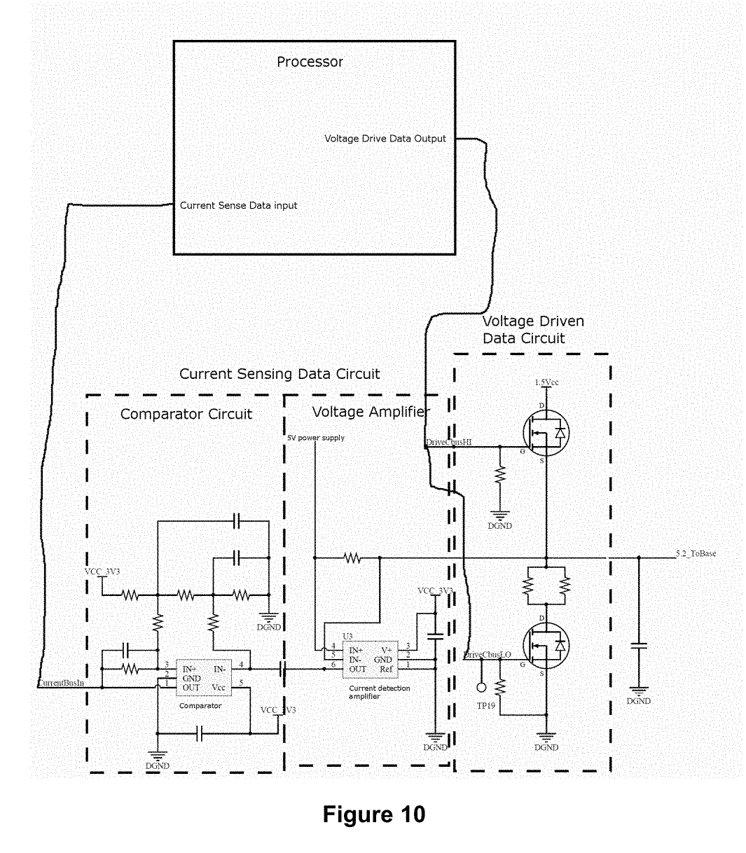

FIG. 7 depicts an example of the FIG. 6 process flow in greater detail. At step 700, the hardware module receives the incoming power (where step 700 can correspond to step 600 from FIG. 6. Then, at step 702, the power and data circuit 504 determines whether is operating in a power mode or a data mode. When in the power mode, the hardware module 300 is simply a pass through where the power received by input interface 502 is passed through via output interface 504. However, when in the data mode, the hardware module 300 encodes data in the output power signal.

Steps 704 and 706 are performed when in the power mode. At step 704, the output voltage is set at Vp, which can be (as an example) a nominal 5V. This voltage Vp is then provided to the output interface 506 for delivery to the product display assembly 102 (step 706).

Steps 714, 716, 718, and 720 are performed when in the data mode. At step 714, the power and data circuit 504 sets the output voltage at Vd, which is chosen as a value less than Vp. For example, if Vp is 5V, then Vd can be set to a lower voltage such as 1.8V. Voltage Vd can be chosen to be a voltage that is below the voltage needed by the puck assembly 202 for normal operations, which allows the puck assembly 202 to detect that the hardware module 300 is attempting to send data to it. In this example, the puck assembly 202 can include a power storage device such as a battery, and the puck assembly 202 can draw power from this power storage device for operation when in response to the input voltage from the hardware module 300 being reduced to a voltage of Vd. A practitioner could choose to make Vd larger than Vp, but the system would likely need further accommodations to handle the higher voltage. As such, it is preferred that Vd be less than Vp so that operation in the data mode can live within the existing confines of the hardware and maintain safe operation while also permitting the circuitry of the product display assembly to easily “ignore” the reduced Vd voltage and then transition to operations from a battery as noted above.

At step 716, the power and data circuit 504 modulates the output voltage to encode data within the output power signal. This can be achieved by toggling the output voltage between Vd and ground at a given data rate (e.g., 2K bits per second). For example, the ground voltage can encode a bit value of “0”, and the voltage Vd (e.g., 1.8V) can encode a bit value of “1”. At step 718, the modulated output voltage is sent to the product display assembly via output interface 506. An example of data that can be encoded at step 716 is an identifier for the hardware module 300 (e.g., a Dongle ID). However, it should be understood that other data could be encoded at step 716. For example, if the hardware module 300 includes a wireless receiver or wireless transceiver, the hardware module 300 can receive a message from a remote computer system, and data within this message could be encoded at step 716 in order to pass such data on to the product display assembly 102.

Then, at step 720, the power and data circuit 504 checks for more data to send. If there is more data, it can return to step 716 and continue modulating the output voltage as appropriate to encode the remaining data. Otherwise, the process flow can return to step 702.

FIG. 8A depicts an example process flow that can be used by the hardware module 300 to receive data from the product display assembly 102. As mentioned above, the puck assembly 202 can communicate data to the hardware module 300 by modulating the current it draws from the hardware module 300. At step 800, the power and data circuit 504 reads this current draw. At step 802, the power and data circuit 504 determines whether this read indicates that the current draw is being modulated. If the current draw is not being modulated, the process flow can return to step 800. But, step 802 results in a determination that the current draw is being modulated, then the process flow can proceed to step 804.

At step 804, the power and data circuit 504 decodes the modulated current draw in order to decode the data embedded in modulated current draw. As the current rises above and below some defined value (e.g., 137.5 mA) at some defined data rate (e.g., 2K bits per second), the power and data circuit 504 can interpret the peaks as “1”s and the troughs as “0”s. The data can thus be extracted as a series of bit values. The data that gets decoded at step 804 can be any of a number of different types of data. For example, the data could be an identifier for an electronic device 106 connected to the product display assembly 102. As another example, the data could be an identifier for the puck assembly 202. As another example, the data could be other data about the product display assembly 102 and/or electronic device 106 such as operating status, charge level, arming/disarming status, etc. The data could also be different types of command requests to be sent by the product display assembly 102 to the hardware module 300 (e.g., a request for the hardware module's identifier, a request for the hardware module's operational status, etc.).

The current draw can be read at step 800 using a current measurement circuit that is in-line with power. The measured current can be converted to a voltage level and compared against a set voltage point. As example, the voltage set point could be 1.4V (although it should be understood that different voltages could be used). This 1.4V could correspond to 140 mA of current. The puck assembly 202 can alternate between drawing current above and below 140 mA (e.g., between 80 mA and 200 mA) to represent a “0” or a “1”. As the puck assembly 202 modulates its current draw between these two values, the current measurement circuit of the hardware module 300 can detect this modulation at step 802 and produce voltages that alternate between 0.8V and 2.0V (which crosses above and below the 1.4V set point voltage on a comparator within the hardware module 300). The comparator can be configured to output anything below 1.4V as a logical low signal (e.g., 0V) and anything above 1.4V as a logical high signal (e.g. 5V) to read the current draw modulation. The output of the comparator can then be fed into a processor (e.g., a microprocessor) which then reads these signals as data bits.

In order to distinguish normal variations in current draw from data signals, the system can employ defined start bytes (e.g., a preamble) in each data message that are recognized by the hardware module 300 as corresponding to message data. Also, a CRC check can be sent with each data message so that the hardware module 300 can verify that a complete data message was sent without error. These controls can help prevent normal variations in current draw from being misinterpreted as data.

Furthermore, current consumption by the puck assembly 202 can be attributed to two primary sources. The first source is the native circuitry of the puck assembly 202 itself and the current it draws for operation (e.g., to monitor security, etc.) As an example, a maximum for this source of current draw can be considered as 60 mA. The second source is when the puck assembly is charging a connected electronic device. This charging and any usage of the electronic device cause additional current draw by the puck assembly 202. As an example, a maximum for this source of current draw can be considered as 3A. When a puck assembly 202 decides to send a data message via current modulation, the puck assembly 202 can be configured to shut off charging to a connected electronic device which would then limit the maximum current draw for the puck assembly 202 to be that corresponding to the puck assembly's native circuitry. The set point used for tripping the 0/1 readings by the hardware module 300 can then be selected as a value larger than the native current draw. The puck assembly 202 could then selectively turn “on” one or more resistors to increase the current draw to a value above the set point that is sufficient to signal a “1” bit. Step 802 can then detect these current modulations by the puck assembly 202, and step 804 can decode them.

FIG. 8B depicts another example process flow that can be used by the hardware module 300 to receive data from the product display assembly 102. Steps 800, 802, and 804 can operate as described above in connection with FIG. 8A. FIG. 8B includes an additional step 806 after step 804. At step 806, the hardware module 300 wirelessly transmits the data decoded at step 804 to a remote computer system via wireless transmitter 510 (which may take the form of a wireless transceiver).

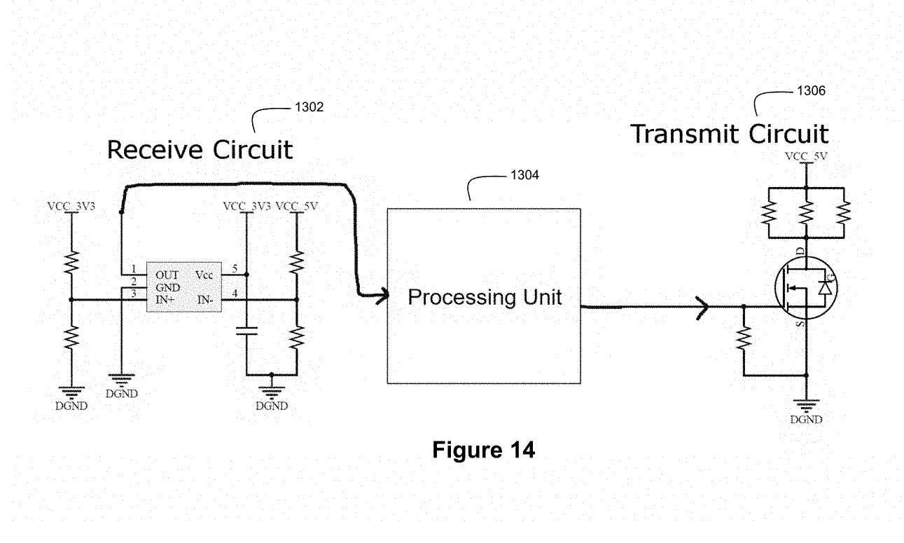

FIG. 9 depicts an example embodiment of the power and data circuit 504. It can include a signal/current demodulation receive circuit 900, a processor 902, and a signal/voltage modulation transmit circuit 904. The receive and transmit circuits 900 and 904 can connect with a power bus 910. When transmitting data, the processor 902 can encode data as described above in connection with FIGS. 6 and 7. The signal/voltage modulation transmit circuit 904 then imparts the modulated output voltage on power bus 910 for transmission to the product display assembly 102 via output interface 506. When receiving data, the signal/current demodulation receive circuit 900 can read and demodulate the current draw on power bus 910, and the processor can then decode this demodulated current draw to extract the relevant data, as discussed in connection with FIGS. 8A and 8B. The processor 902 can be any suitable processor (such as a microprocessor) for carrying out the data encoding or decoding operations described herein. Moreover, the processor 902 can include associated memory for storing digital data to be encoded in the power signal or digital data decoded from a modulated current draw. Moreover, if such processor 902 has a unique identifier such as a unique serial number, this identifier could be used as the Dongle ID. Thus, in an embodiment where the hardware module 300 sends its Dongle ID to the product display assembly 102 via modulation of the output voltage, the processor's serial number can be used as the Dongle ID that gets encoded at steps 602/716.

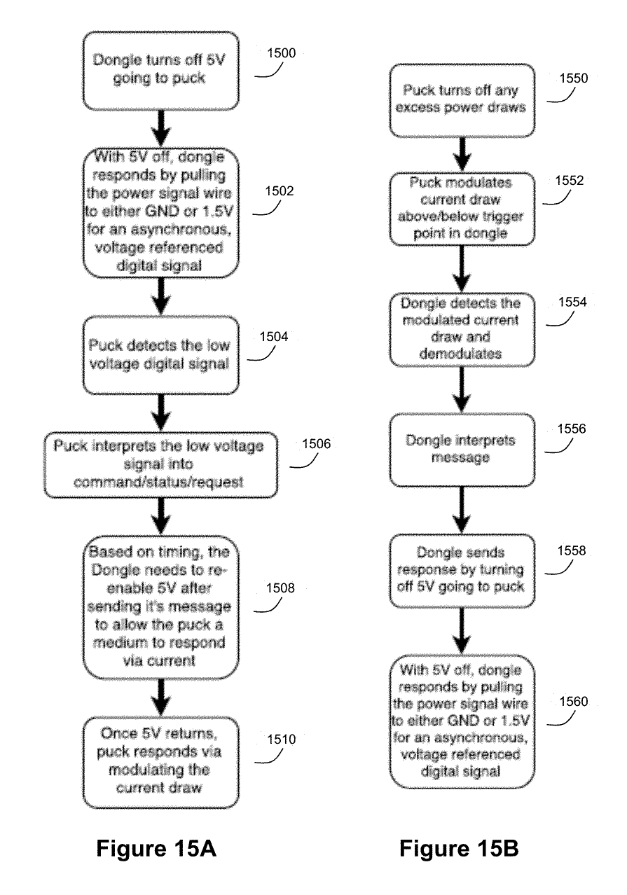

FIG. 10 shows an example circuit diagram for the power and data circuit 504. In this example, the signal/current demodulation receive circuit 900 can take the form of a current sensing data circuit that includes a voltage amplifier and a comparator circuit. The signal/voltage modulation transmit circuit can take the form of a voltage driven data circuit. The voltage amplifier of the current sensing data circuit can include a current sense resistor and a current detection amplifier that amplifies the voltage across the current sense resistor. This amplification can bring the measured voltage up to more easily usable levels (e.g., volts instead of tens of millivolts). The comparator circuit can then digitize the analog voltage from the amplifier using a set voltage point as a threshold for high/low bits.

Thus, it should be understood that the hardware module 300 can support bi-directional communication with a puck assembly 202 in a manner that is transparent to the base assembly 204. Thus, the hardware module 300 can be an effective tool for retrofitting legacy base assemblies with location awareness and data connectivity as discussed above and below.

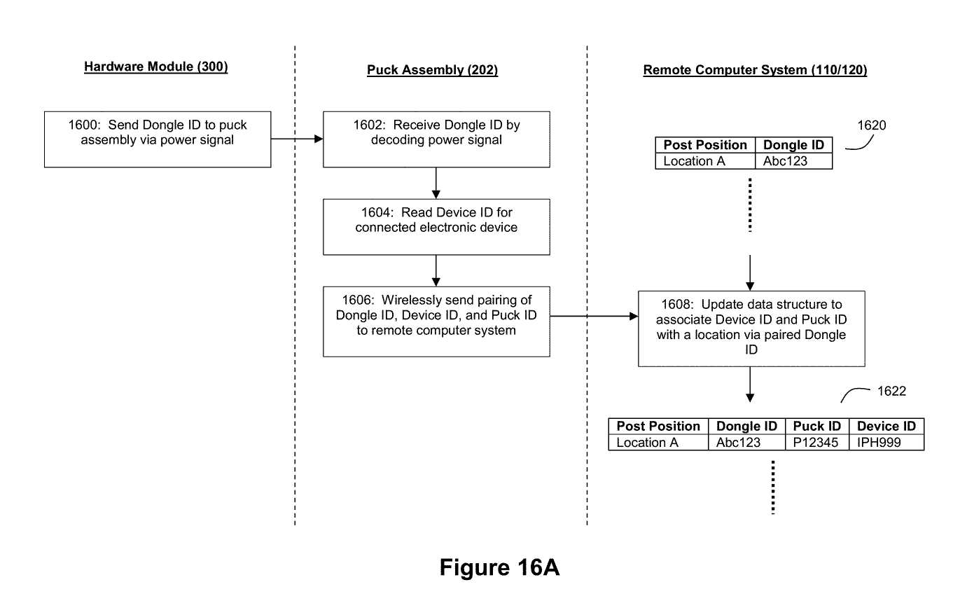

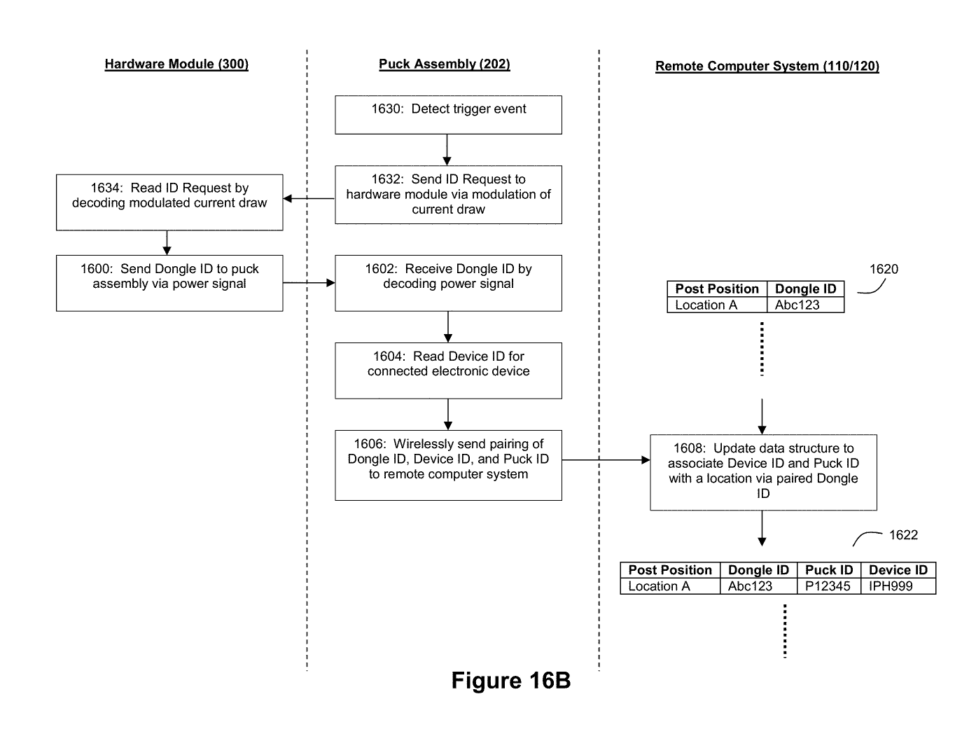

To support the communication capabilities discussed herein, the puck assembly 202 can also be configured with voltage demodulation and current modulation capabilities. FIG. 11 describes an example process flow for the puck assembly 202 to receive and interpret messages from the hardware module 300. FIG. 12 describes an example process flow for the puck assembly 202 to send messages to the hardware module 300.

In an example embodiment, the puck assembly 202 can listen for data after it has first sent a message (where the puck assembly 202 serves as a master and the hardware module 300 serves as a slave). Thus, after sending a data message, the puck assembly 202 can start listening for data coming back (and switch the puck assembly over to battery power for running operations such as puck security). It can be in this mode for a defined duration if desired by a practitioner. At step 1100 of FIG. 11, the puck assembly reads the input voltage from the hardware module 300 (as passed by the base assembly 204). In an example embodiment where the puck assembly 202 can be lifted from the base assembly, this step 1100 can require that the puck assembly 202 be in the rest position on the base assembly 204 so that an electrical connection is made between the puck assembly 202 and base assembly 204 (e.g., via complementary contacts on the puck and base assemblies). At step 1102, the puck assembly compares the read input voltage with Vt. If the input voltage is greater than Vt, the puck assembly can conclude that a logical “1” is being sent as data. If the input voltage is less than Vt, the puck assembly can conclude that assembly logical “0” is being sent as data. Moreover, as noted above, because the high end of the voltage modulation for data messaging will be at some value below the normal operating voltage for the puck assembly 202, the puck assembly 202 can switch over to battery power for running operations such as puck security while reading voltage modulation data. At step 1104, the puck assembly decodes the data in the modulated input voltage with reference to the threshold Vt. The bit scheme and data rate used by the hardware module 300 can be known to the puck assembly and used at step 1104 to decode the data embedded in the input power signal.

In another example embodiment, the puck assembly 202 can be configured to always listen for data rather than listening in response to messages it sent. In such an embodiment, the puck assembly 202 can check for transitions of the input voltage above/below the threshold Vt, and it can continuously try to construct a set preamble with specific timings based on the established preamble for messaging. This preamble would thus be used to filter out normal voltage transients that may occur during normal usage that is not intended as a data message. When a preamble is recognized with appropriate timing, the puck assembly 202 can read the remainder of message and verify by CRC.

At step 1200 of FIG. 12, the puck assembly determines whether it has data to send to the hardware module 300. If yes, the process flow can proceed to step 1202. Once again, in an example embodiment where the puck assembly 202 can be lifted from the base assembly, this step 1200 can require that the puck assembly 202 be in the rest position on the base assembly 204 in order to transition to step 1202 because the electrical connection that is made between the puck assembly 202 and base assembly 204 (e.g., via complementary contacts on the puck and base assemblies) when at rest will need to be present in order for the current modulation data transfer technique to operate. At step 1202, the puck assembly modulates the current it draws from the hardware module 300 at the nominal voltage (e.g., 5V) rail (via the base assembly 204) to encode the data that will get communicated to the hardware module 300 via the modulated current draw.

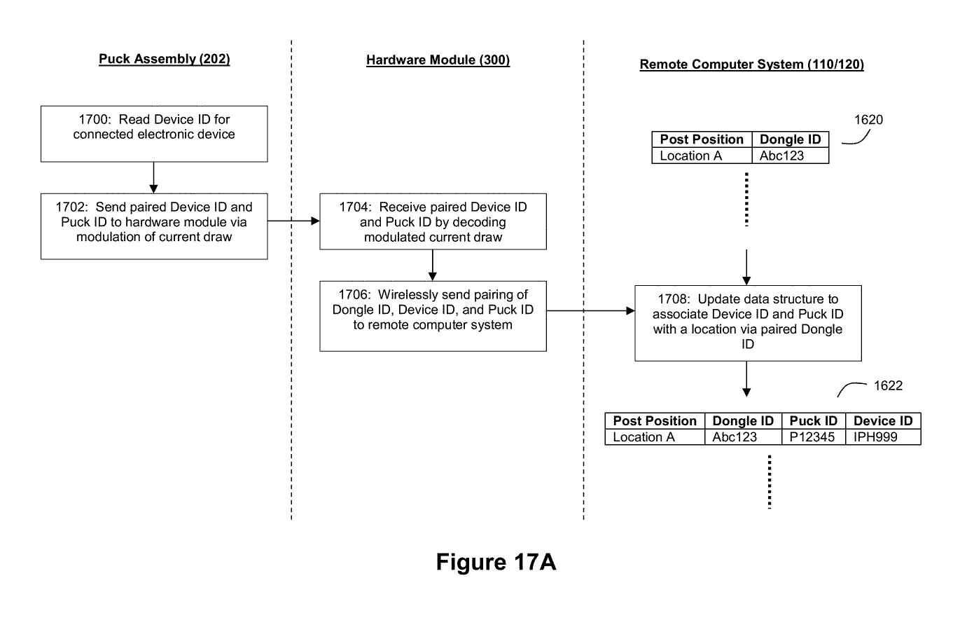

FIG. 13 depicts an example embodiment of circuitry 1300 in the puck assembly 202 for supporting communications with the hardware module 300. The circuitry 1300 can include a signal/voltage demodulation receive circuit 1302, a processor 1304, and a signal/current modulation transmit circuit 1306. The receive and transmit circuits 1302 and 1306 can connect with a power bus 1310. When transmitting data, the processor 1304 can encode data as described above in connection with FIG. 12 via modulation of the current it draws from power bus 1310. The signal/current modulation transmit circuit 1306 then draws the modulated current from power bus 1310 for data transmission to the hardware module 300. When receiving data, the signal/voltage demodulation receive circuit 1302 can read and demodulate the input voltage on power bus 1310, and the processor can then decode this demodulated voltage to extract the relevant data, as discussed in connection with FIG. 11. The processor 1304 can be any suitable processor (such as a microprocessor) for carrying out the data encoding or decoding operations described herein.

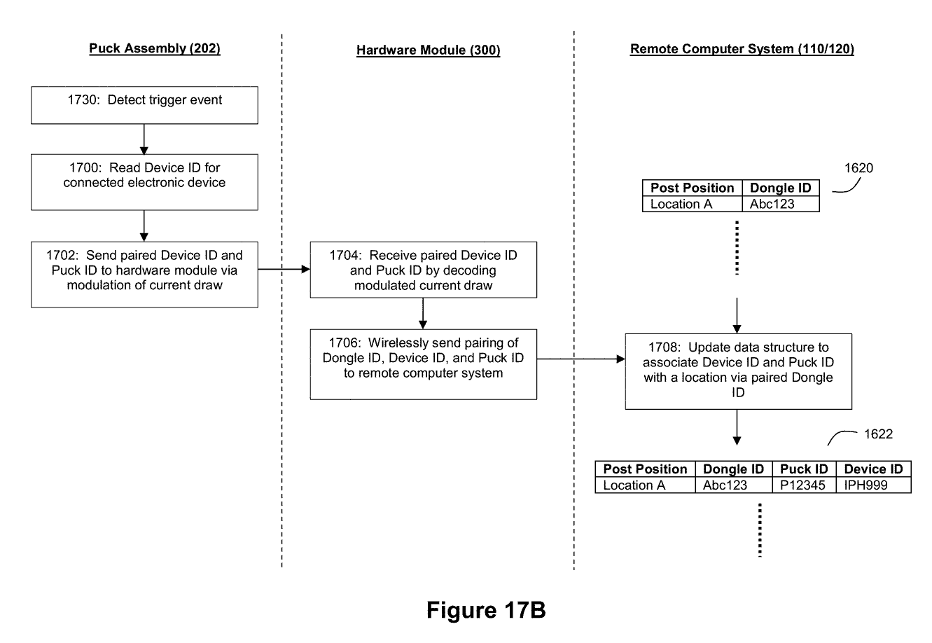

FIG. 14 shows example circuit diagrams for the signal/voltage modulation circuit 1302 and the signal/current modulation transmit circuit 1304. The signal/voltage modulation receive circuit 1302 can include a comparator that looks at the input voltage and compares it against Vt. If the input voltage (see VCC_5V in FIG. 14) is less than Vt, the output of the comparator would be a low (e.g., ground or 0V). If the input voltage is greater than Vt, the output of the comparator would be a high (e.g., Vcc or 3.3V). This output from the comparator is provided to processor 1304 and serves as a data stream of highs/lows to represent “1”s and “0” s. The signal/current modulation transmit circuit 1306 operates as a current modulator. It receives a digital signal from the processor 1304. When this digital signal is high, the FET turns on, which adds the three resistors to the power/current load of the puck assembly 202. The resistors can be sized to guarantee that the current draw by the puck assembly 202 is now above the threshold used by the hardware module 300 (e.g., 140 mA). When the processor outputs a low, the FET takes the resistors out of the circuit, and the current draw of the puck assembly 202 drops back down to the native current draw of the puck assembly which is less than the threshold used by the hardware module 300.

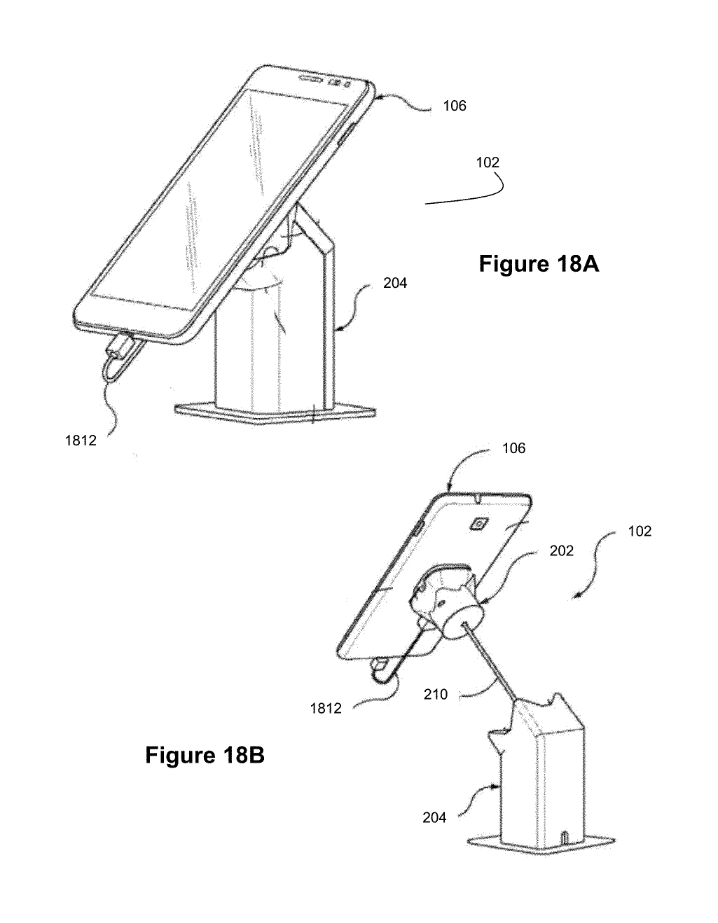

FIG. 15A shows an example process flow for end-to-end data communication initiated by the hardware module 300 (e.g., dongle). At step 1500, the dongle turns off the 5V signal going to the puck assembly. At step 1502, the dongle pulls the power signal wire to either ground or 1.5V for encoding an asynchronous voltage-referenced digital signal. The puck assembly then detects this low voltage digital signal (step 1504). At step 1506, the puck assembly interprets this low voltage digital signal by decoding it and interpreting the signal as a command/status/request as may be appropriate. Then, after a defined amount of time has passed, the dongle re-enables the 5V signal going to the puck assembly (step 1508). This provides the puck assembly with a medium through which it can respond to the signal via current modulation. Then, at step 1510, after 5V has been returned to the puck assembly, the puck assembly responds to the signal from the dongle by modulating its current draw (which, as explained above, is effective for communicating data to the dongle).

FIG. 15B shows an example process flow for end-to-end data communication initiated by the puck assembly 202. At step 1550, the puck assembly turns off any excess power draws by stopping any charging that is being provided to a connected electronic device. As noted above, this can be done to reduce the risk of unpredictable current draw profiles through the puck assembly 202 that might confuse data communications. Then, at step 1552, the puck assembly modulates its current draw above/below a trigger point in the dongle. At step 1554, the dongle detects the modulated current draw, and it demodulates the modulated current draw. At step 1556, the dongle detects the message in the demodulated current draw, and then the dongle initiates a response message back to the puck assembly by turning off the 5V going to the puck assembly (step 1558). After the 5V has been turned off, the dongle can create a message for delivery to the puck assembly by pulling the power signal wire to either ground or 1.5V for encoding an asynchronous voltage-referenced digital signal (step 1560).

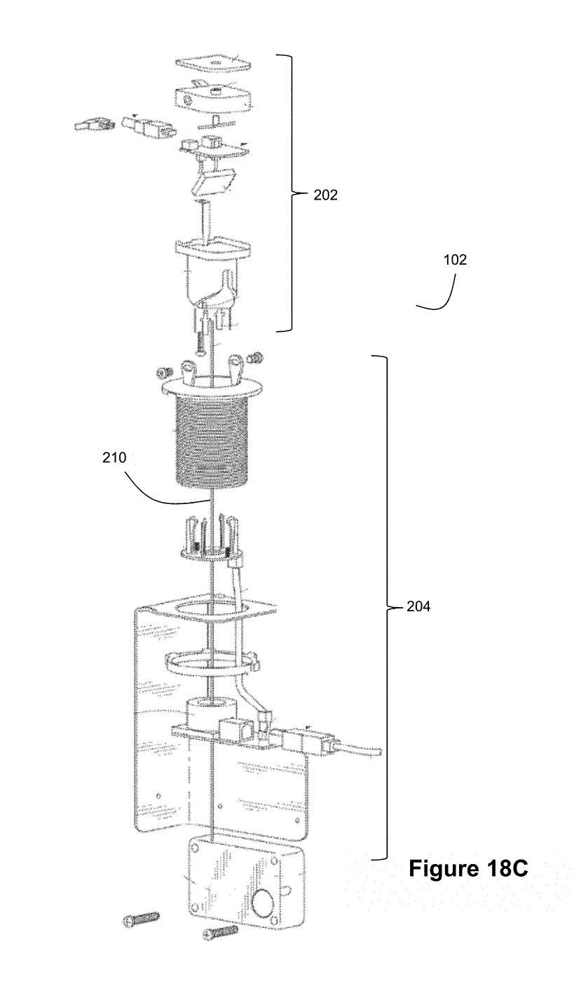

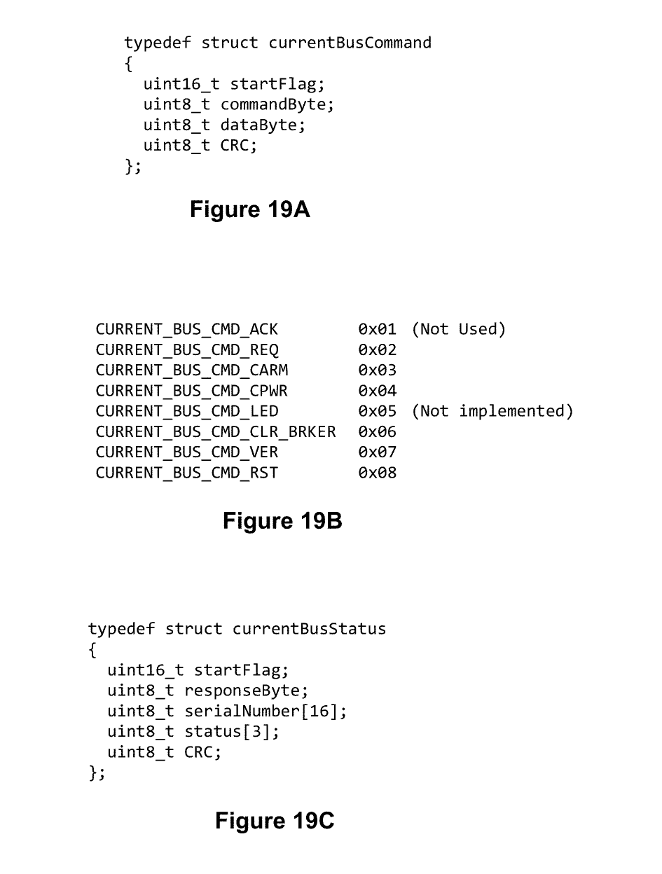

FIGS. 16A, 16B, 17A, and 17B show example process flows that leverage the hardware module 300 to provide location-awareness for the system regarding where puck assemblies 202 and electronic devices 106 are located relative to known locations such as post positions. As mentioned above, because base assemblies 204 are expected to be relatively fixed in terms of their locations in retail stores, while puck assemblies 202 and electronic devices 106 may change their locations in the retail store fairly often, the hardware module 300 and data communication capabilities described herein provide practitioners with opportunities for improved location tracking of electronic devices 106 and assessing planogram compliance. FIGS. 16A and 16B show examples where the puck assembly 202 is configured to wirelessly communicate with the remote computer system, while FIGS. 17A and 17B show examples where the hardware module 300 is configured to wirelessly communicate with the remote computer system.

As shown by FIG. 16A, a remote computer system such as gateway computer 110 and/or server 120 can maintain a data structure 1620 that associates identifiers for the hardware modules 300 (e.g., Dongle IDs) with locations in a store (e.g., post positions). The post positions can be known locations within a planogram for a store, and these locations can be defined with respect to frames of reference defined by a planogram in any of a number of manners. For example, in some instances, a planogram could define post positions in a relative manner that is not true to scale with respect to the spatial geometry of a store (e.g., Post Position 1 is the front row leftmost position on a defined table, Post Position 2 is the front row, second from the left position on the defined table, . . . , Post Position N is the back row, rightmost position on the defined table, etc.). However, other stores may define planograms in a more scaled manner where the post positions are represented with more geographical precision. However, the post positions need not be defined with the precision of GPS coordinates or the like unless desired by a practitioner.

Base assemblies 204 can have known post positions in stores, and the associations in data structure 1620 can be created by registering which hardware modules 300 are connected with which base assemblies 204. Registration can be carried out as a set up operation in software. Uncorrelated positions (e.g., base assemblies that do not have known post positions) can be placed on a software-defined planogram, and then each of these uncorrelated positions can be registered with a post position using a hardware module 300 and a set up process. As hardware modules 300 are connected to uncorrelated base assemblies 204 and the product display assemblies 102 start coming online with gateway computer 110, the gateway computer will start seeing data that represents pairings between Dongle IDs and identifiers for puck assemblies 202 (Puck IDs). The gateway computer 110 can then issue wireless commands that correspond to “identify” requests to each of the uncorrelated product display assemblies 102 that will cause a status indicator such as an LED on the subject product display assembly 102 to identify itself (e.g., blink in a certain way). This identification can allow a user to physically identify a given product display assembly 102 at a given post position with the pairing data, which allows the system to register a given hardware module 300 with a given post position in data structure 1620. In another example registration process, post positions can be manually labeled with respective codes or other unique identifiers and hardware modules can be manually labeled with their Dongle IDs, and a user can manually enter a pairing between these values in the system to create data structure 1620.

Once a Dongle ID has been associated with a post position, the system next needs to learn which puck assembly 202 and/or electronic device 106 is located at that post position. FIG. 16A shows an example process flow for this.

At step 1600, the hardware module 300 sends its Dongle ID to the puck assembly via voltage modulation of the power signal as discussed above in connection with FIGS. 6 and 7. At step 1602, the puck assembly 202 receives this Dongle ID by decoding the modulated power signal as discussed above in connection with FIG. 11. The puck assembly 202 can also read the identifier for the electronic device 106 (Device ID) that is connected to the puck assembly 202 (step 1604). For example, with reference to FIGS. 18A and 18B, this determination can be made by reading data about the electronic device 106 through cable 1812. Through this cable 1812, the electronic device 106 can provide its Device ID to the puck assembly 202, and this Device ID can identify a make and model for the electronic device (e.g., an Apple iPhone X) as well as a serial number. For example, upon connection, an electronic device 106 that is a USB device can output data that includes USB device descriptors. Device type can be determined from such descriptors. For example, the puck assembly 202 can use base level descriptors that are broadcast in response to connection and also implement USB classes to query the device further e.g., USB image class, USB mass storage device class, etc.). This allows the puck assembly 202 to pair the Dongle ID with the Device ID, and this pairing of Dongle ID with Device ID can be wirelessly sent from the puck assembly 202 to the remote computer system at step 1606. The puck assembly 202 may also send its own puck assembly identifier (Puck ID) to the remote computer system at step 1606, which would pair the Dongle ID with the Device ID and the Puck ID. At step 1608, the remote computer system receives this pairing of Dongle ID with Device ID (or Dongle ID with Device ID and Puck ID), and it updates the data structure to associate the Device ID (or Device ID and Puck ID) with a post position by virtue of the shared Dongle ID (see data structure 1622). Thus, it can be seen that data structure 1622 tracks which electronic devices 106 are at which post positions, and it can also track which puck assemblies 202 are at which post positions.

The example of FIG. 16B shows an example where the puck assembly 202 initiates the location-aware pairing operation. At step 1630, the puck assembly 202 detects a trigger event, and this trigger event causes the puck assembly 202 to send a request for the hardware module's identifier (Dongle ID) to the hardware module 300 using the current modulation techniques described in connection with FIG. 12 (step 1632). At step 1634, the hardware module receives and decodes the ID request using the current demodulation techniques discussed above in connection with FIG. 8A. Upon recognizing the decoded ID request, the hardware module performs step 1600 as discussed above in connection with FIG. 16A, and the remaining steps 1602, 1604, 1606, and 1608 can be performed as described above in connection with FIG. 16A.

Any of a number of trigger events can be used at step 1630 to initiate the operation of pairing the Dongle ID with the Device ID and/or Puck ID. For example, the trigger event can be anytime that the puck assembly 202 detects a detachment from the base assembly 204 and/or tether 210 (which may indicate movement of the puck assembly 202 to a new post position, in which case the need for re-pairing may arise). The trigger event can also a detection by the puck assembly 202 that it has lost power. Another example of a trigger event can be the detection of a new connection with an electronic device 106 (e.g., via cable 1812). Yet another example of a trigger event can be a detection that the puck assembly 202 has been lifted. Yet another example of a trigger event can be an expiration of a timer (which would define a timed basis for triggering the pairing operation so that the system can regular re-pair and confirm which electronic devices 106 are at which post positions). Yet another example of a trigger event can be a command sent from the computer system 110/120 in response to a user request through interface 130 to force a re-pairing.

As mentioned above, FIGS. 17A and 17B show examples where the hardware module 300 is configured to wirelessly communicate with the remote computer system. The example of FIG. 17A can begin at step 1700 with the puck assembly 202 reading the Device ID for its connected electronic device 106 (where this step can be performed in a similar fashion as step 1604 from FIGS. 16A and 16B). At step 1702, the puck assembly 202 sends the Device ID (or the Device ID paired with the Puck ID) to the hardware module 300 using the current modulation techniques discussed above in connection with FIG. 12. At step 1704, the hardware module 300 receives and decodes the Device ID (or the Device ID paired with the Puck ID) using the current demodulation techniques discussed above in connection with FIG. 8A. Then, at step 1706, the hardware module 300 reads its Dongle ID and sends a pairing of the Dongle ID with the decoded Device ID (or a pairing of the Dongle ID with the decoded Device ID and Puck ID) to the remote computer system using wireless transmitter 510. At step 1708, the remote computer system receives this pairing of Dongle ID with Device ID (or Dongle ID with Device ID and Puck ID), and it updates the data structure 1620 to associate the Device ID (or Device ID and Puck ID) with a post position by virtue of the shared Dongle ID (see data structure 1622).

The example of FIG. 17B shows an example where the puck assembly's detection of a trigger event at step 1730 initiates the pairing operation. The trigger event(s) used at step 1730 can be the same as those discussed above in connection with step 1630 of FIG. 16B.

Thus, as the process flows of FIGS. 16A, 16B, 17A, and/or 17B are repeated for different product display assemblies 102 in a retail store (or in multiple retail stores), the data structure 1622 can allow for highly detailed planogram monitoring in real-time and around the clock, both on a per-retail store basis and on a multi-retail store basis. For example, a software application run by the remote computer system can compare data structure 1622 with a planogram. In response to the comparison, the software application can determine whether at least one of the electronic devices is located in an incorrect location. If so, the software application can generate a notification about the incorrect location, and this notification can be delivered to interested parties, such as personnel in the retail store who can move the electronic device to the correct location. Retail store personnel can receive such notifications on their smart phones and/or tablet computers. Further still, as customers interact with the product display assembly (such as by lifting a puck assembly 202 to inspect an electronic device 106), these actions can be detected and tracked by the product display assembly 102 and reported to the remote computer system using the techniques described in the above-referenced and incorporated '140 patent. The remote computer system can then correlate this lift tracking data with the data structure 1622 to reliably know precisely which electronic devices are being inspected at which post positions.

Furthermore, while the examples of FIGS. 16A, 16B, 17A, and 17B use the Dongle ID of the hardware module 300 to tie Device IDs and Puck IDs to post positions, it should be understood that the techniques of FIGS. 16A, 16B, 17A, and 17B could also be applied to base assemblies 204 rather than hardware modules 300 if the base assemblies are equipped with a base assembly identifier that can be reported out like the Dongle ID (and the base assembly 204 includes the voltage modulation, current demodulation, and data encoding/decoding circuitry discussed above in connection with FIGS. 9 and 10).

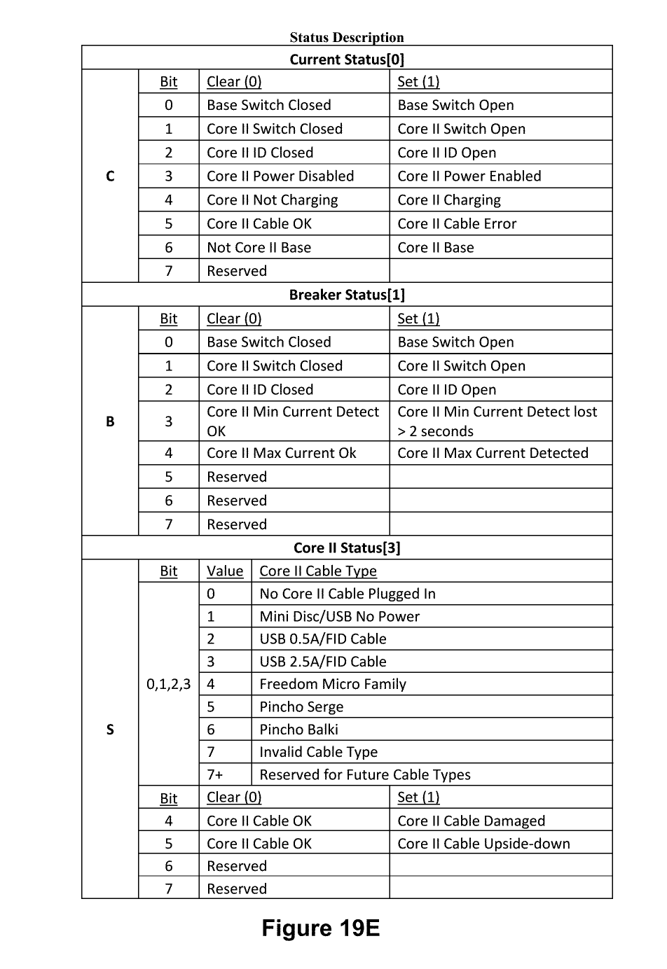

FIGS. 19A-E describe an example protocol that can be used by the hardware module 300 and puck assembly 202 to communicate messages to each other. However, it should be understood that different communication protocols could be used. In this example protocol, the puck assembly 202 can be the master and it can request status from the hardware module 300. Prior to sending a start flag, the puck assembly 202 can hold the line low for greater than 1 ms.

FIG. 19A shows a packet structure that can be used by all messages from the puck assembly to the hardware module 300. The parameter startFlag can be used to lock onto the message, and it can be set to a value such as 0xAAAA. The parameter commandByte is the specific command for each message as shown in FIG. 19B. The parameter dataByte is specific to the commandByte used as shown by FIG. 19D. CRC is the checksum. To calculate the CRC, one can add commandByte and dataByte, invert the result, and then add 1.

FIG. 19C shows the packet structure that can be used by all messages from the hardware module 300 to the puck assembly 202. The parameter startFlag can be used to lock onto the message, and it can be set to a value such as 0xAAAA. The parameter responseByte is the commandByte that was received from the puck assembly. The parameter serialNumber can be a 16 byte unique identifier for the hardware module 300 (e.g., pulled from processor 902). Status is specific to the responseByte used, as shown by FIG. 19D. CRC is the checksum. To calculate the CRC, one can add all bytes except startFlag, invert the result, and then add 1.

FIG. 19E shows examples of Status bytes that can be included in response messages.

Also, while the example embodiments discussed above employ the hardware module 300 in cooperation with product display assemblies 202 for securely presenting electronic devices 106 to consumers in a retail store setting, it should be understood that the hardware module 300 could also be used with other items of equipment. For example, the hardware module 300 could be used in combination with a docking station for an electronic device where the hardware module 300 is connected in-line with the power input for a base of the docking station. A frame assembly may enclose the electronic device, and this frame assembly may dock with the base. Data can be communicated between the hardware module 300 and the frame assembly and/or electronic device using the techniques described herein. For example, the hardware module 300 could be used to provide location awareness for the electronic devices that get docked with the base. Thus, if the frame assembly includes a wireless transmitter or wireless transceiver, the frame assembly can wirelessly communicate a pairing between a Dongle ID and a Device ID (and also a Frame Assembly ID if desired) to a remote computer system as described above in connection with a product display assembly 102. Similarly, the electronic device itself could be leveraged to wirelessly communicate a pairing between a Dongle ID and a Device ID (and also a Frame Assembly ID if desired) to a remote computer system. As another example, the hardware module 300 could be connected to an electronic device 106 or an accessory for an electronic device 106 (e.g., speakers, headphones, etc.)

While the invention has been described above in relation to its example embodiments, various modifications may be made thereto that still fall within the invention's scope. Such modifications to the invention will be recognizable upon review of the teachings herein.

What is claimed is:

1. An apparatus comprising:
a hardware module for in-line power connection with an item of equipment, the hardware module comprising (1) a first interface, (2) a second interface, and (3) a circuit that connects the first interface with the second interface;
the first interface configured to receive power;
the circuit configured to (1) generate a power signal based on the received power, (2) encode data in the power signal, and (3) provide the power signal with the encoded data therein to the second interface; and
the second interface configured to output the power signal with the encoded data therein for receipt by the equipment item to thereby communicate the data to the equipment item.

2. The apparatus of claim 1 wherein the data comprises an identifier for the hardware module.

3. The apparatus of claim 2 wherein the circuit comprises a processor, the processor having a serial number, wherein the serial number serves as the identifier.

4. The apparatus of claim 1 wherein the circuit is further configured (1) generate the power signal at a first voltage for providing power to the equipment item, and (2) generate the power signal at a second voltage lower than the first voltage for providing encoded data to the equipment item.

5. The apparatus of claim 4 wherein the second voltage comprises a plurality of voltages that are lower than the first voltage.

6. The apparatus of claim 4 wherein the circuit comprises a voltage modulator circuit configured to modulate the second voltage to encode the data.

7. The apparatus of claim 6 wherein the power connection includes a current draw by the equipment item, and wherein the circuit is further configured to receive data from the equipment item based on a modulation of the current draw.

8. The apparatus of claim 7 wherein the circuit comprises a voltage modulator, the voltage modulator configured to translate the modulated current draw into a plurality of voltages that represent the data from the equipment item.

9. The apparatus of claim 7 wherein the circuit further comprises a processor and a memory, the processor configured to (1) read the voltages, and (2) store the data in the memory as digital data based on the read voltages.

10. The apparatus of claim 1 wherein the hardware module further comprises at least one of a wireless receiver, a wireless transmitter, and/or a wireless transceiver for wirelessly communicating with a remote computer system.

11. The apparatus of claim 1 wherein the data comprises a message.

12. The apparatus of claim 11 wherein the message comprises at least one of (1) a request for status message, (2) an arm command message, (3) a disarm command message, (4) a request for an identifier message, and (5) an acknowledgement request.

13. The apparatus of claim 1 wherein the hardware module is arranged as a dongle.

14. The apparatus of claim 1 wherein the first interface comprises a connector configured to connect with a complementary connector of a power cord that receives power from a power supply.

15. The apparatus of claim 1 wherein the second interface comprises a connector configured to connect with a complementary connector of a power cord that connects with a power input of the equipment item.

16. A system comprising:
an equipment item having a power input; and
a hardware module comprising (1) a first interface, (2) a second interface, and (3) a circuit that connects the first interface with the second interface;
wherein the first interface is configured to interface the circuit with a power source;
wherein the second interface is configured to interface the circuit with the power input of the equipment item; and
wherein the circuit is configured to (1) generate a power signal based on power received from a power source through the first interface, (2) encode data in the power signal, and (3) communicate the power signal, including the encoded data, to the equipment item via the second interface and the power input.

17. The system of claim 16 wherein the equipment item comprises a product display assembly.

18. The system of claim 17 wherein the product display assembly comprises:
a puck assembly adapted to receive an electronic device; and
a base assembly;
wherein the puck assembly is adapted to be moveable between (1) a rest position in which the puck assembly is engaged with the base assembly, and (2) a lift position in which the puck assembly is disengaged from the base assembly;
wherein the base assembly comprises base assembly circuitry configured to receive the power signal and transfer power from the power signal to the puck assembly;
wherein the puck assembly comprises puck assembly circuitry configured to receive power from the base assembly.

19. The system of claim 18 wherein the base assembly includes the power input.

20. The system of claim 18 wherein the power received by the puck assembly circuitry includes the encoded data; and
wherein the puck assembly circuitry is further configured to decode the data from the received power.

21. The system of claim 20 wherein the puck assembly circuitry is further configured to decode the data from the received power based on voltage demodulation.

22. The system of claim 20 wherein the puck assembly circuitry further comprises at least one of a wireless transmitter and a wireless transceiver for wirelessly transmitting the data to a remote computer system.

23. The system of claim 22 wherein the data comprises an identifier for the hardware module; and
wherein the puck assembly circuitry is further configured to (1) read an identifier for the electronic device, and (2) wirelessly transmit the hardware module identifier and the electronic device identifier to the remote computer system.

24. The system of claim 23 further comprising:
the remote computer system, wherein the remote computer system is configured to create a data structure that associates the electronic device identifier with the hardware module identifier.

25. The system of claim 24 wherein the remote computer system is further configured to associate the hardware module identifier with a location in a retail store such that the data structure also associates the electronic device identifier with the location.

26. The system of claim 25 wherein the location comprises a post position in the retail store, the post position corresponding to where the base assembly is located.

27. The system of claim 25 further comprising:
a plurality of the hardware modules, puck assemblies, and base assemblies for use with a plurality of electronic devices in a plurality of retail store locations; and
wherein the data structure maps a plurality of the electronic devices to a plurality of different locations.

28. The system of claim 23 wherein the puck assembly has a puck assembly identifier, and wherein the puck assembly circuitry is further configured to wirelessly transmit the hardware module identifier, the electronic device identifier, and the puck assembly identifier to the remote computer system.

29. The system of claim 28 wherein the remote computer system is further configured to associate the puck assembly identifier with the location that is associated with the hardware module identifier.

30. The system of claim 18 wherein the puck assembly is usable with and moveable between a plurality of different base assemblies.

31. The system of claim 18 wherein the product display assembly further comprises a tether assembly adapted to connect the puck assembly with the base assembly;
wherein the puck assembly is adapted to be moveable between (1) a rest position in which (i) the puck assembly is engages with the base assembly and (ii) the puck assembly and the base assembly are connected to the tether assembly, and (2) a lift position in which (i) the puck assembly is disengaged from the base assembly and (ii) the puck assembly and the base assembly are connected to the tether assembly.

32. The system of claim 31 wherein the puck assembly is detachable from the tether assembly.

33. The system of claim 16 wherein the equipment item comprises a docking station for an electronic device.

34. A method comprising:
connecting a hardware module between a power input of an item of equipment and a power source; and
in response to the connecting, the hardware module (1) receiving power from the power source, (2) generating a power signal based on the received power, (3) encoding data in the power signal, and (4) providing the power signal, including the encoded data, to the power input of the equipment item.

35. A system comprising:
a puck assembly for a product display assembly, the puck assembly adapted to receive an electronic device; and
a circuit for connection with a power source, the circuit configured to provide a power signal for the puck assembly and encode a message to the puck assembly in the power signal;
wherein the puck assembly includes puck assembly circuitry configured to extract the message from a signal derived from the power signal.

36. The system of claim 35 wherein the circuit is resident in a base assembly for the product display assembly.

37. The system of claim 35 wherein the circuit is resident in a hardware module for connection to a base assembly of the product display assembly, the hardware module comprising a first interface for connection to the power source and a second interface for connection to a power input of the base assembly.
